(19) United States
(12) Patent Application Publication
(10) Pub. No.: US 2006/0012483 A1
(43) Pub. Date: Jan. 19, 2006

(54) Water safety device

(76) Inventor: Billy Ethington, San Antonio, TX (US)

Correspondence Address: WAYNE J COLTON INC;THE MILAM BUILDING SUITE 1032, 115 EAST TRAVIS STREET, SAN ANTONIO, TX, 78205, US

(21) Appl. No.: 10/893,286

(22) Filed: Jul. 16, 2004

(51) Int. Cl. G08B 23/00; G08B 21/00

(52) U.S. Cl. 340/573.6; 340/686.6; 340/604

(57) ABSTRACT

A water safety device includes a transmitter device adapted for operation with an alarm and search console. The transmitter device includes an alerting unit and an associated activation sensor. Activation of the alerting unit results in the transmission from the alerting unit to the alarm and search console of a tracking signal. The activation sensor may be any transducer or combination of transducers capable of sensing physical phenomenon generally concomitant a fall into water from a boat or ship. The alerting unit is adapted to immediately begin transmission of a predetermined signal for tracking of the life preserver and transmitter device by the alarm and search console following activation by the activation sensor. The alerting unit may be adapted to cause automated inflation of one or more inflatable bladders upon any indication that the wearer of the water safety device has fallen from the boat or ship.

### FIELD OF THE INVENTION

The present invention relates to water safety. More particularly, the invention relates to a water safety device adapted to automatically activate a tracking signal upon fall of a person from a ship or boat into surrounding water.

### BACKGROUND OF THE INVENTION

Every year numerous recreational boaters and shipboard workers are lost to drowning, in many cases only because others on board do not realize that a person has fallen overboard until the fallen person is hopelessly lost. Although the provision of life vests and the like serve to reduce the risk of drowning, they do nothing to facilitate location of a fallen person. As a result, it is an overriding object of the present invention to provide a method and apparatus though which others aboard ship are automatically and immediately alerted to the possibility that a person has fallen overboard. Additionally, it is an object of the present invention to provide such a method and apparatus that also facilitates location and retrieval of the fallen person. Still further, it is an object of the present invention to provide such a method and apparatus that is comfortable to wear, even while working, thereby ensuring its maximum use.

### SUMMARY OF THE INVENTION

In accordance with the foregoing objects, the present invention—a water safety device—generally comprises a transmitter device adapted for operation with an alarm and search console. The transmitter device includes an alerting unit and an associated activation sensor. Activation of the alerting unit—based upon detection by the activation sensor of the existence of one or more predetermined physical conditions—results in the transmission from the alerting unit to the alarm and search console of a tracking signal.

In the preferred embodiment of the present invention, the activation sensor comprises any transducer or combination of transducers capable of sensing physical phenomenon generally concomitant a fall into water from a boat or ship. For example, the activation sensor may comprise an accelerometer or other impact sensor adapted to detect the sudden jolt expected as a person impacts the surface of the water. Likewise, the activation sensor may comprise a moisture detector or the like for detecting physical presence of the water about the fallen person. In the alternative or in combination with the foregoing, the activation sensor may comprise a proximity detector such as, for example, a radio receiver with a signal strength indicator.

The alerting unit, which may comprise a transmitter or transceiver, is adapted to immediately begin transmission of a predetermined signal for tracking of the life preserver and transmitter device by the alarm and search console following activation by the activation sensor. Additionally, the alerting unit is preferably adapted to cause automated inflation of one or more inflatable bladders upon any indication that the wearer of the water safety device has fallen from the boat or ship. To this end, the alerting unit is preferably provided with an inflation controller for automatically activating one or more carbon dioxide canisters.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1 shows, in a perspective view, the preferred embodiment of the major components of the water safety device of the present invention; and

FIG. 2 shows, in a schematic block diagram, the water safety device of FIG. 1.

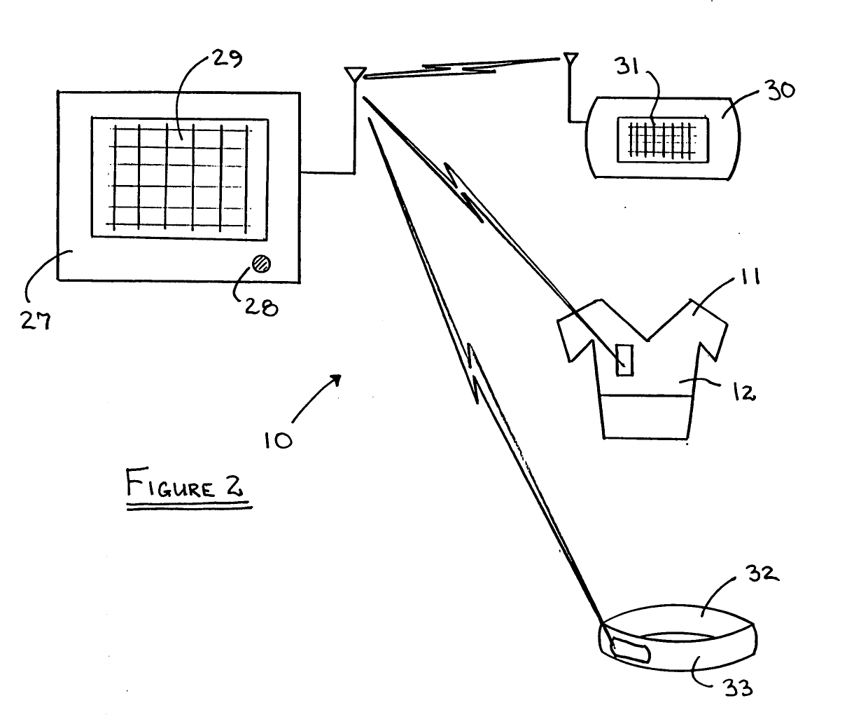

### DETAILED DESCRIPTION OF THE PREFERRED EMBODIMENT

Although those of ordinary skill in the art will readily recognize many alternative embodiments, especially in light of the illustrations provided herein, this detailed description is exemplary of the preferred embodiment of the present invention, the scope of which is limited only by the claims appended hereto.

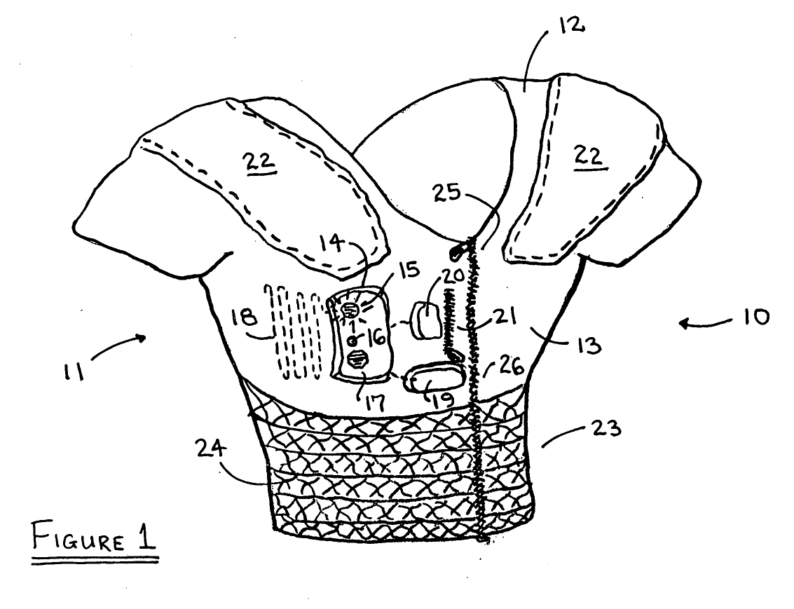

Referring now to the figures, and to FIG. 1 in particular, the water safety device 10 of the present invention is shown to preferably comprise a combination life preserver and transmitter device 11 adapted for operation with an alarm and search console 27. As shown in FIG. 1, the combination life preserver and transmitter device 11 comprises a vest 12, which preferably takes the form of closely conforming body suit, having disposed in its upper portion 13 an alerting unit 14 and an associated activation sensor 19. As will be better understood further herein, activation of the alerting unit 14—based upon detection by the activation sensor 19 of the existence of one or more predetermined physical conditions—results in the transmission from the alerting unit 14 to the alarm and search console 27 of a tracking signal.

In the preferred embodiment of the present invention, the activation sensor 19 comprises any transducer or combination of transducers capable of sensing physical phenomenon generally concomitant a fall into water from a boat or ship. For example, the activation sensor 19 may comprise an accelerometer or other impact sensor—components well known to those of ordinary skill in the art—adapted to detect the sudden jolt expected as a person impacts the surface of the water. Likewise, the activation sensor 19 may comprise a moisture detector or the like—also well known to those of ordinary skill in the art—for detecting physical presence of the water about the fallen person. In the alternative or in combination with the foregoing, the activation sensor 19 may comprise a proximity detector such as, for example, a radio receiver with a signal strength indicator. As will be appreciated by those of ordinary skill in the art, a sensor 19 of this nature may be implemented to monitor for the presence of a weak signal generated at the alarm and search console 27. The activation sensor 19, in such a case, will detect a decrease in signal strength with separation from the area of the alarm and search console 27 of the life preserver and transmitter device 11. Detection of the diminished or lost signal will serve as the triggering device for the activation sensor 19. Finally, it is noted that those of ordinary skill in the art will recognize other possible implementations for the activation sensor 19, especially in light of the foregoing examples. All such implementations should be considered within the scope of the present invention.

Regardless of the particular implementation for the activation sensor 19, the alerting unit 14, which may comprise a transmitter or transceiver, is adapted to immediately begin transmission of a predetermined signal for tracking of the life preserver and transmitter device 11 by the alarm and search console 27 following activation by the activation sensor 19. Additionally, the alerting unit 14 is preferably adapted to cause automated inflation of one or more inflatable bladders 22 upon any indication that the wearer of the water safety device 10 has fallen from the boat or ship. To this end, the alerting unit 14 is preferably provided with an inflation controller for automatically activating one or more carbon dioxide canisters, the implementation of which is readily within the ordinary skill in the art.

In order to provide confirm to the fallen person that the water safety system 10 has been activated, as well as to provide some measure of comfort, the alerting unit is also preferably provided with an indicator light 15, which may also facilitate location of the fallen person. As will be appreciated by those of ordinary skill in the art, this provision gives the wearer an opportunity to manually activate the alerting unit 14 by actuating a manual activation device 16, which may comprise a simple pushbutton or other type switch. Additionally, the alerting unit may be provided with a speaker or combination speaker and microphone through which verbal communication between operators of the alarm and search console 27 and the fallen wearer of the combination life preserver and transmitter device 11 may be established.

In order to promote use of the water safety device 10 of the present invention, the combination life preserver and transmitter device 11 is preferably formed as a closely conforming body suit, as previously discussed. In this manner, the vest 12 is adapted to prevent interference with the wearer's shipboard duties. To this end, the lower portion 23 may comprise a mesh material 24, thereby ensuring that the vest 12 is secure on the person while providing for ample breathing. In order to facilitate ease of application, a simple closure 25, such as a zipper 26, may be provided.

Upon activation, an audible indicator 28 such as, for example, a buzzer or loud horn and/or a visual indicator such as, for example, a light emitting diode or the like, is turned on at the alarm and search console 27 thereby alerting others to the possibility of a person overboard. Rescuers may then utilize a search screen 29 provided on the alarm and search console to obtain the relative position of the fallen person. As will be appreciated by those of ordinary skill in the art, such position information may be obtained by simple direction finding or by utilization of satellite tracking such as the Global Positioning System (“GPS”). In the case of GPS, the alerting unit may be provided with a GPS receiver and be adapted to transmit the received signal to the alarm and search console 27 for decoding.

To further facilitate search and rescue operations, one or more portable or handheld locator units 30 may be used in conjunction with the foregoing apparatus. Such a unit preferably comprises a search screen 31 like the search screen 29 of the main alarm and search console 27. The portable unit 30, however, may simply receive tracking information form the main console 27 rather than making its own calculations, thereby allowing for size and cost reductions.

While the foregoing description is exemplary of the preferred embodiment of the present invention, those of ordinary skill in the relevant arts will recognize the many variations, alterations, modifications, substitutions and the like as are readily possible, especially in light of this description, the accompanying drawings and claims drawn thereto. For example, those of ordinary skill in the art will recognize that other components such as, for example, a battery pack 20 will be required for operation of the present invention. Likewise, such a battery pack should be readily accessible through a watertight enclosure 21 through the vest 12 such as a watertight zipper.

Those of ordinary skill in the art will similarly recognize, in light of this exemplary description, that the antenna 18 for the alerting unit should be embedded within the vest 12 to prevent damage and/or interference with the wearer's non-emergency routine. To this end, it is noted that the alerting unit 14 and activation sensor 19 may be implemented in a low profile transmitter device 32 such as, for example, an armband or a belt 33, which may or may not be provided with flotation properties as desired. In any case, because the scope of the present invention is much broader than any particular embodiment, the foregoing detailed description should not be construed as a limitation of the scope of the present invention, which is limited only by the claims appended hereto.

What is claimed is:

1. A water safety device, said water safety device comprising:
an alarm console;
an alerting unit for transmitting an emergency signal to said alarm console; and
an activation sensor associated with said alerting unit, said activation sensor being adapted to detect a fall into water by a wearer of the water safety device.

2. The water safety device as recited in claim 1, wherein said activation sensor comprises an impact sensor.

3. The water safety device as recited in claim 2, wherein said impact sensor comprises an accelerometer.

4. The water safety device as recited in claim 1, wherein said activation sensor comprises a moisture detector.

5. The water safety device as recited in claim 1, wherein said activation device comprises a proximity detector.

6. The water safety device as recited in claim 5, wherein said proximity detector comprises a radio signal strength detector.

7. The water safety device as recited in claim 1, wherein said alerting unit and activation sensor are integrated into a life vest.

8. The water safety device as recited in claim 7, wherein said life vest comprises an automatically inflating floatation device.

9. The water safety device as recited in claim 8, wherein said inflation of said flotation device is triggered by detection of a fall by said activation device.

10. The water safety device as recited in claim 1, wherein said alerting unit and activation sensor are integrated into a belt.

11. The water safety device as recited in claim 1, wherein said alerting unit and activation sensor are integrated into an armband.
